(19) United States
(12) Patent Application Publication
(10) Pub. No.: US 2008/0076189 A1
(43) Pub. Date: Mar. 27, 2008

(54) MODIFIED SURFACES FOR THE DETECTION OF BIOMOLECULES AT THE SINGLE MOLECULE LEVEL

(75) Inventors: Yuri Belosludtsev, The Woodlands, TX (US); Nasanshargal Battulga, Houston, TX (US); Mistu Reddy, Pearland, TX (US); Anelia Kraltcheva, Houston, TX (US); Susan H. Hardin, College Station, TX (US); Tommie L. Lincecum JR., Houston, TX (US); Hongyi Wang, Houston, TX (US); Norha Deluge, Houston, TX (US); Uma Nagaswamy, Houston, TX (US); Benjamin C. Stevens, Houston, TX (US); Kristi K. Kincaid, Houston, TX (US)

Correspondence Address: ROBERT W STROZIER, P.L.L.C, PO BOX 429, BELLAIRE, TX, 77402-0429, US

(73) Assignee: VISIGEN BIOTECHNOLOGIES, INC., Houston, TX (US)

(21) Appl. No.: 11/694,605

(22) Filed: Mar. 30, 2007

Related U.S. Application Data
(60) Provisional application No. 60/787,434, filed on Mar. 30, 2006.

(51) Int. Cl. G01N 21/64

(52) U.S. Cl. 436/172

(57) ABSTRACT

Support surfaces are disclosed that are designed to support molecules or molecular assemblies immobilized thereon so that the molecules or molecular assemblies can be observed in single molecule detections systems, where the support surfaces have reduced background and the fluorescent labels associated with the immobilized molecules or molecular assemblies have longer active lifetimes prior to permanent photo-bleaching or deactivation and have improve fluorescence properties and where the surfaces have more uniform fluorescent properties.

### RELATED APPLICATIONS

This application claims priority to U.S. Provisional Patent Application Ser. No. 60/787,434, filed 30 Mar. 2007.

### BACKGROUND OF THE INVENTION

1. Field of the Invention

The present invention relates to surface compositions that delay fluorescent dye or fluorophore permanent photo-bleaching or permanent deactivation and improve fluorescent dye or fluorophore properties such as reduced blinking, improved fluorescent spectra characteristics, etc.

More particularly, the present invention relates to surface compositions having properties that delay fluorescent dye or fluorophore permanent photo-bleaching or permanent deactivation and improve dye or fluorophore properties such as reduced blinking, improved fluorescent spectra characteristics, etc., where the composition includes a substrate and an absorption layer absorbed on a surface of the substrate. Stated positively, the present compositions extend fluorescent dye or fluorophore life time. The present invention also relates to surface compositions including a substrate having a surface functionalized with a functionalizing agent and an absorption layer absorbed on the functionalized surface of the substrate. The present invention also relates to such surface compositions upon which sequencing complexes including a fluorescent dye or fluorophore are immobilized. The present invention also relates to nucleic acid sequencing using such surface compositions with immobilized sequencing complexes and an extension solutions, where sequencing information is determined by measuring fluorophore fluorescence from donor dyes or fluorophores (donors) and/or acceptor dyes or fluorophores (acceptors) directly and/or by measuring fluorescence from donors and/or acceptors excited by donors via fluorescence resonance energy transfer (FRET). The present invention also relates to method for making such surface compositions, apparatuses for making such surface compositions and sequencing method using such surface compositions.

2. Description of the Related Art

Most single molecule detection systems involve immobilizing molecular systems on a support surface in such a way that a majority of the molecular systems are isolated from each other so that each can be detected/analyzed separately. However donor-dye deactivation is always a problem in such systems, e.g., U.S. patent application Ser. Nos. 09/901,782 and 10/007,621, incorporated herein by reference.

Thus, there is a need in the art for surfaces that delay dye or fluorophore fluorescence permanent photo-bleaching or dye permanent deactivation or alternatively to improve dye or fluorophore life times and improve dye or fluorophore fluorescent properties—reduce blinking, improve fluorescent spectra characteristics, etc., especially in single molecule settings, where dye permanent deactivation is a major difficulty in permitting detecting of sequential reactions such as nucleic acid sequencing or other sequential single molecule reactions.

### DEFINITIONS

Unless stated otherwise, the following terms and phrases as used herein are intended to have the following meanings:

The term molecule means a single molecular entity.

The term molecular complex means a collection of single molecular entities such as a primer/template duplex, a polymerase/primer/template sequencing complex, or other collections of single molecular entities.

The term molecular assembly means a collection of molecules and molecular complexes such as a ribosomal assembly used in protein synthesis. Assemblies can be thought of as large complexes, but is meant to include collections of associated complexes and molecules.

The term species means a molecule, molecular complex, a molecular assembly or a mixture or combination thereof. That is, species is a generic term to represent single molecules, complexes, assemblies or a mixture or combination of single molecules, complexes, assemblies.

The term monomer as used herein means any compound that can be incorporated into a growing molecular chain by a given polymerase. Such monomers include, without limitations, naturally occurring nucleotides (e.g., ATP, GTP, TTP, UTP, CTP, DATP, dGTP, dTTP, dUTP, dCTP, synthetic analogs), precursors for each nucleotide, non-naturally occurring nucleotides and their precursors or any other molecule that can be incorporated into a growing polymer chain by a given polymerase. Additionally, amino acids (natural or synthetic) for protein or protein analog synthesis, mono saccharides for carbohydrate synthesis or other monomeric syntheses.

The term polymerase as used herein means any molecule or molecular assembly that can polymerize a set of monomers into a polymer having a predetermined sequence of the monomers, including, without limitation, naturally occurring polymerases or reverse transcriptases, mutated naturally occurring polymerases or reverse transcriptases, where the mutation involves the replacement of one or more or many amino acids with other amino acids, the insertion or deletion of one or more or many amino acids from the polymerases or reverse transcriptases, or the conjugation of parts of one or more polymerases or reverse transcriptases, non-naturally occurring polymerases or reverse transcriptases. The term polymerase also embraces synthetic molecules or molecular assembly that can polymerize a polymer having a pre-determined sequence of monomers, or any other molecule or molecular assembly that may have additional sequences that facilitate purification and/or immobilization and/or molecular interaction of the tags, and that can polymerize a polymer having a pre-determined or specified or templated sequence of monomers.

The term “bonded to” means that chemical and/or physical interactions sufficient to maintain the polymerizing agent within a given region of the substrate under normal polymerizing conditions. The chemical and/or physical interactions include, without limitation, covalent bonding, ionic bonding, hydrogen bonding, a polar bonding, attractive electrostatic interactions, dipole interactions, or any other electrical or quantum mechanical interaction sufficient in toto to maintain the polymerizing agent in a desired region of the substrate.

The term “heterogeneous” assay as used herein refers to an assay method where in at least one of the reactants in the assay mixture is attached to a solid phase, such as a solid support.

The term “oligonucleotide” as used herein includes linear oligomers of nucleotides or analogs thereof, including deoxyribonucleosides, ribonucleosides, and the like. Usually, oligonucleotides range in size from a few monomeric units, e.g. 3-4, to several hundreds of monomeric units. Whenever an oligonucleotide is represented by a sequence of letters, such as “ATGCCTG”, it will be understood that the nucleotides are in 5′-3′ order from left to right and that “A” denotes deoxyadenosine, “C” denotes deoxycytidine, “G” denotes deoxyguanosine, and “T” denotes thymine, unless otherwise noted.

The term “nucleoside” as used herein refers to a compound consisting of a purine, deazapurine, or pyrimidine nucleoside base, e.g., adenine, guanine, cytosine, uracil, thymine, deazaadenine, deazaguanosine, and the like, linked to a pentose at the 1′ position, including 2′-deoxy and 2′-hydroxyl forms, e.g., as described in Komberg and Baker, DNA Replication, 2nd Ed. (Freeman, San Francisco, 1992) and further include, but are not limited to, synthetic nucleosides having modified base moieties and/or modified sugar moieties, e.g. described generally by Scheit, Nucleotide Analogs (John Wiley, N.Y., 1980). Suitable NTPs include both naturally occurring and synthetic nucleotide triphosphates, and are not limited to, ATP, DATP, CTP, dCTP, GTP, dGTP, TTP, dTTP, ITP, dITP, UTP and dUTP. Preferably, the nucleotide triphosphates used in the methods of the present invention are selected from the group of DATP, dCTP, dGTP, dTTP, dUTP and mixtures thereof.

The term “nucleotide” as used herein refers to a phosphate ester of a nucleoside, e.g., mono, di and triphosphate esters, wherein the most common site of esterification is the hydroxyl group attached to the C-5 position of the pentose and includes deoxyribonucleoside triphosphates such as DATP, dCTP, dITP, dUTP, dGTP, dTTP, or derivatives thereof such as their dideoxy derivatives: ddATP, ddCTP, ddITP, ddUTP, ddGTP, ddTTP. Such derivatives include, for example [aS]dATP, 7-deaza-dGTP and 7-deaza-dATP. The term “nucleotide” as used herein also refers to ribonucleoside triphosphates (NTPs) and their derivatives. Illustrated examples of ribonucleoside triphosphates include, but are not limited to, ATP, CTP, GTP, ITP and UTP.

The term “primer” refers to a linear oligonucleotide which specifically anneals to a unique polynucleotide sequence and allows for amplification of that unique polynucleotide sequence or to a nucleic acid, e.g., synthetic oligonucleotide, which is capable of annealing to a complementary template nucleic acid and serving as a point of initiation for template-directed nucleic acid synthesis. Typically, a primer will include a free hydroxyl group at the 3′-end.

The phrase “sequence determination” or “determining a nucleotide sequence” in reference to polynucleotides includes determination of partial as well as full sequence information of the polynucleotide. That is, the term includes sequence comparisons, fingerprinting, and like levels of information about a target polynucleotide, or oligonucleotide, as well as the express identification and ordering of nucleotides, usually each nucleotide, in a target polynucleotide. The term also includes the determination of the identification, ordering, and locations of one, two, or three of the four types of nucleotides within a target polynucleotide.

The term “solid-support” refers to a material in the solid-phase that interacts with reagents in the liquid phase by heterogeneous reactions. Solid-supports can be derivatized with proteins such as enzymes, peptides, oligonucleotides and polynucleotides by covalent or non-covalent bonding through one or more attachment sites, thereby “immobilizing” the protein or nucleic acid to the solid-support.

The phrase “target nucleic acid” or “target polynucleotide” refers to a nucleic acid or polynucleotide whose sequence identity or ordering or location of nucleosides is to be determined using methods described herein.

The term “primer-extension reagent” means a reagent including components necessary to effect the enzymatic template-mediated extension of a primer. Primer extension reagents include: (i) a polymerase enzyme, e.g., a thermostable polymerase enzyme such as Taq DNA polymerase, and the like; (ii) a buffer to stabilize pH; (iii) deoxynucleotide triphosphates, e.g., deoxyguanosine 5′-triphosphate, 7-deazadeoxyguanosine 5′-triphosphate, deoxyadenosine 5′-triphosphate, deoxythymidine 5′-triphosphate, deoxycytidine 5′-triphosphate; and, optionally in the case of a Sanger-type DNA sequencing reaction, (iv) dideoxynucleotide triphosphates, e.g., dideoxyguanosine 5′triphosphate, 7-deazadideoxyguanosine 5′-triphosphate, dideoxyadenosine 5′-triphosphate, dideoxythymidine 5′-triphosphate, dideoxycytidine 5′-triphosphate, and the like.

As used herein, the term “pyrophosphate” refers to two phosphate molecules bound together by an ester linkage, e.g., the structure ⁻²O³P—O—PO₃⁻².

The term “nucleotide-degrading enzyme” as used herein includes all enzymes capable of non-specifically degrading nucleotides, including at least nucleoside triphosphates (NTPs), but optionally also di- and monophosphates, and any mixture or combination of such enzymes, provided that a nucleoside triphosphatase or other NTP degrading activity is present. Although nucleotide-degrading enzymes having a phosphatase activity may conveniently be used according to the invention, any enzyme having any nucleotide or nucleoside degrading activity may be used, e.g., enzymes which cleave nucleotides at positions other than at the phosphate group, for example at the base or sugar residues. Thus, a nucleoside triphosphate degrading enzyme is essential for the invention.

The term “atomic tag” means an atom or ion of an atom that when attached to a nucleotide increase the fidelity of a nucleotide polymerizing agent such as a polymerase at the atom tagged nucleotide is incorporated into a nucleotide sequence.

The term “molecular tag” means an atom or ion of an atom that when attached to a nucleotide increase the fidelity of a nucleotide polymerizing agent such as a polymerase at the atom tagged nucleotide is incorporated into a nucleotide sequence.

The term “polymerizing agent” means any naturally occurring or synthetic agent capable of polymerizing nucleotides to produce polynucleotide, including polymerases, reverse transcriptases, or the related naturally occurring nucleotide polymerizing systems. The term polymerizing agent also includes variants of naturally occurring polymerases or reverse transcriptases where one or more amino acids have been added to, removed from or replaced in the nature amino acid sequence. Thus, the term covers all known and to be constructed systems capable of forming oligomers or polymers of nucleotides.

### SUMMARY OF THE INVENTION

The present invention provides a surface composition including a transparent substrate, transparent within a desired range of frequencies of electromagnetic radiation or a desired region of the electromagnetic spectrum and an absorption layer absorbed onto a surface of the substrate, where the absorption layer comprises an absorbent. The composition can also include a functionalized layer interposed between the substrate and the absorption layer, where the functionalized layer comprises a functionalizing agent. The composition can further include one molecule, molecular complex or molecular assembly or a plurality of molecules, molecular complexes, molecular assemblies, or mixtures or combinations thereof, where each molecule, complex or assembly includes a fluorescent dye, fluorophore or detectable group and where each molecule, complex or assembly is immobilized on the composition. When a plurality of molecules, complexes or assemblies are immobilized on the composition, then a majority of the molecules, complexes or assemblies are isolated one from the other. The composition can further include a plurality of sequencing complexes including a polymerizing agent, a primer and a nucleic acid template, immobilized on the composition, where a majority of the complexes are isolated from each other and each complex includes a fluorescent donor dye or fluorophore. The composition can further include a plurality of nucleotide types or deoxynucleotide triphosphate (dNTPs) types for the polymerizing agent, at least one nucleotide or dNTP type including or bearing an acceptor fluorescent dye or fluorophore (sometimes referred to only as an acceptor) capable of undergoing fluorescent resonance energy transfer (FRET) with an excited fluorescent donor dye or fluorophore (sometimes referred to only as a donor). It should be understood that when the inventors speak of a nucleotide or dNTP type including or bearing an acceptor, they mean for example, all dATPs bear or include an acceptor, all dTTPs bear or include an acceptor, all dCTPs bear or include an acceptor, all dGTPs bear or include an acceptor. In certain embodiments, each nucleotide type bears or includes an acceptor and each acceptor is the same or different. It should also be understood that the donor can be covalently bonded directly or through a linker to any position on the primer, template or polymerizing agent provided that if the donor is for fluorescence resonance energy transfer (FRET) to an acceptor, that the donor must be accessible to light and accessible to acceptors, where accessible to the acceptor means that a distance between the donor and acceptor must be sufficient to support FRET. Generally, this distance is within about 100 Å. In certain embodiments, the distance is tailored to be within about 60 Å. In other embodiments, the distance is tailored to be within about 25 Å. In other embodiments, the distance is tailored to be within about 15 Å. In other embodiments, the distance is tailored to be within about 10 Å. It should also be understood that the donor can also be associated with the sequencing complex such as a persistent fluorescent quantum dot or other persistent fluorescent nano-structure associated with the sequencing complex or the sequencing complex or a member thereof can be attached to a persistent fluorescent quantum dot or other nano-structure. It should also be understood that the acceptor can be covalently bonded directly or through a linker to an position on a nucleotide or dNTP, such as the base, sugar, or phosphates. By isolated, the inventors mean that the species are sufficient separated so that each can be independently identified using an imaging system or other detection system.

The present invention provides a method for delaying fluorescent dye or fluorophore permanent photo-bleaching or deactivation and improving dye or fluorophore fluorescent properties such as reduced blinking, improved fluorescent spectra characteristics, etc. The method includes the step of providing a composition comprising a transparent substrate, transparent within a desired range of frequencies of electromagnetic radiation, an optional functionalized layer, an absorption layer and a dye layer immobilized on the composition. The functionalized layer comprises a functionalizing agent; the absorption layer comprises an absorbent; and the dye layer comprising a molecule or molecular assembly including a fluorescent dye. The method also includes the step of irradiating the composition with light of a frequency sufficient to excite the dye and detecting fluorescent light emitted from the excited dye. The method also includes the step of determining fluorescent properties of the dye including a density of detectable dyes within regions on the composition, within a viewing field or field of view of the composition, and dye fluorescent properties such as persistence, lifetime, blinking, etc.

The present invention provides a method for delaying fluorescent dye or fluorophore permanent photo-bleaching or dye deactivation and improving dye or fluorophore fluorescent properties such as reduced blinking, improved fluorescent spectra characteristics, etc. The method includes the step of providing a composition comprising a transparent substrate, transparent within a desired range of frequencies of electromagnetic radiation, an optional functionalized layer, an absorption layer and a primer/template layer immobilized on the composition. The functionalized layer comprises a functionalizing agent; the absorption layer comprises an absorbent; and primer/template layer comprises a primer including a donor dye and a nucleic acid template in a nucleic acid duplex. Alternatively, the method can include the step of forming a persistent fluorescent quantum dot or other persistent fluorescent nano-structure layer on the composition, where a majority of the dots or nano-structures are isolated on the composition and forming a primer/templated duplex layer on the composition, where at least one primer/template duplex is associated with each persistent fluorescent quantum dot or other nano-structure. The method also includes the step of composition contacting the composition with a polymerizing agent to form immobilized pre-sequencing complexes on the composition, where a majority of the complexes are isolated from each other and each complex includes a donor, a fluorescent donor dye or fluorophore. The method also includes the step of adding an extension solution including a plurality of nucleotide or deoxynucleotide triphosphate (dNTPs) types for the polymerizing agent, at least one and generally at least two nucleotide or DNTP types (e.g., all dATPs, all dCTPs, all dGTPs, all dTTPs, or mixtures of the nucleotide types or DNTP types) include an acceptor, an acceptor fluorescent dye or fluorophore, capable of undergoing fluorescent resonance energy transfer with an excited donor, where the acceptors are generally different so that their fluorescent spectrum can be distinguished. However, in certain embodiments, two nucleotide or dNTP types can have the same acceptor, where the nucleotide or DNPT types are distinguished based on other factors such as timing, duration, shifts in the fluorescent spectrum, etc. The method also includes the step of irradiating the polymerizing compositions with light of a frequency to photo-excite the donor, while leaving a majority of the acceptors in their ground state or non-photo-excited state. The method also includes the step of measuring fluorescent light emitted from an acceptor, a donor, and/or an acceptor energized by an excited donor via fluorescent resonance energy transfer. The method can also include the step of relating the measured fluorescent light to a sequence of acceptor labeled nucleotide or dNTP incorporation events. It should be understood that the term nucleotide or dNTP includes naturally occurring nucleotides or dNTPs, synthetic nucleotides or dNTPs, other molecules that can be incorporated onto a primer duplexed to a template using a polymerizing agent such as a polymerase, reverse transcriptase, or the like, and such nucleotide, dNTP, or molecule having an acceptor and/or a timing moiety covalently bonded to the nucleotide, dNTP, or molecule. The acceptor is generally bonded to the nucleotide, dNTPs, or molecule through a linker that can be any divalent moiety including 1 to 30 carbon atoms, where one or more carbon atoms can be substituted by a hetero atom or hetero atom containing groups selected from the group consisting of B, N, O, S, P, —PO₄—, —CON—(amide), —COO— (ester), —OCOO— (anhydride), —NCON—, —CSN—, —NCSN—, —CSO—, —OCSO—, or the like, or mixtures or combinations thereof.

The present invention provides a method for preparing surface compositions having delayed fluorescent dye or fluorophore permanent photo-bleaching or deactivation and improved dye or fluorophore fluorescent properties such as reduced blinking, improved fluorescent spectra characteristics, etc., including the step of cleaning a substrate. The cleaning step can be any process known to clean surfaces of undesired fluorophores and to activate the surface for subsequent modification. Such treatment include acid or base washes, mixtures of acid and base washes, and/or plasma treatments, and/or other cleaning methods known in the art. The method can optionally include the step of contacting the cleaned substrate with a functionalizing agent to form a functionalized layer on the substrate. The method also includes the step of contacting the cleaned substrate or the functionalized substrate with as an absorbent to form an absorption layer on a surface of the substrate. The absorption layer generally has the following properties: (1) an affinity for the cleaned substrate or for the functionalized substrate, (2) low fluorescent or phosphorescent properties, when the composition is exposed to light within a desired range of frequencies of electromagnetic radiation (light), and (3) an affinity for absorbing a molecule or molecular assembly to be analyzed such as dye-labeled molecules, dye-labeled polymerizing agents, dye-labeled primers or dye-labeled templates, dye-labeled sequencing complexes or other dye labeled molecules or molecular assemblies, or other dye-labeled molecules or molecular assemblies for single molecule analysis, and (4) a low affinity for absorbing acceptor dye labeled molecules, where the acceptor dye labeled molecules are designed to interact with the donor-dye label molecules or complexes immobilized on the surface compositions of this invention. For dye persistence testing, the method can also include immobilizing a molecule including a dye on the compositions. For sequencing, the method can also include the step of immobilizing pre-sequencing complexes on the composition, where the pre-sequencing compositions include a polymerizing agent, a primer and a template, at least one of which includes a donor. The method can also include the step of contacting the resulting composition with an extension solution including nucleotide or deoxynucleotide triphosphate (dNTP) types for the polymerizing agent or interaction partner, at least one type and generally two types of the nucleotide triphosphates or dNTPs include acceptors, where an excited donor and the acceptor can undergo fluorescence resonance energy transfer (FRET) and where the acceptors can be the same or different, but if the same, the incorporation dynamics of the dNTPs or nucleotides are distinguishable.

Although the above embodiments of this invention are directed to fluorescence, the surface compositions of this invention are suitable for immobilizing other molecules, molecular complexes, or molecular assemblies including a label capable of being analyzed using an appropriate analytical detection technique. Thus, the compositions can be used to support molecules or molecular systems for transmission or reflectance spectroscopy, for Raman spectroscopy, for IR, near IR, or far IR spectroscopy, for microwave spectroscopy, for UV, far UV or X-ray spectroscopy, or for any other spectrometry method capable of measuring single molecules or molecular systems. However, the surfaces can also be used for analyzing macroscopic surface properties as well because the surfaces provide an improved uniformity of immobilized molecules, molecular complexes and molecular assemblies.

### BRIEF DESCRIPTION OF THE DRAWINGS

The invention can be better understood with reference to the following detailed description together with the appended illustrative drawings in which like elements are numbered the same.

FIG. 1A depicts a schematic drawing of a first embodiment of a surface composition of this invention.

FIG. 1B depicts a schematic drawing of a second embodiment of a surface composition of this invention.

FIG. 2 depicts an apparatus for functionalizing a substrate.

FIGS. 3A&B depict photographs of surfaces of this invention having dyes immobilized thereon showing emission signatures of immobilized dyes and background using a polymerizing agent.

FIG. 3C depicts a photograph of a surface of this invention having dyes immobilized thereon showing emission signatures of immobilized dyes and background using a polymerizing agent having reduced activity.

FIGS. 4A&B depict life time data on Streptavidin treated, Si-epoxy functionalized glass for duplex binding before polymerase extension reaction and post polymerase extension reaction, respectively.

FIGS. 5A&B depict life time data on Streptavidin treated glass for duplex binding before polymerase extension reaction and post polymerase extension reaction, respectively.

FIGS. 6A&B depict life time data on polyelectrolyte functionalized glass for duplex binding before polymerase extension reaction and post polymerase extension reaction, respectively.

### DETAILED DESCRIPTION OF THE INVENTION

The inventors have found that surface compositions can be constructed for use in single molecular fluorescence detection, especially for single molecule sequencing detection, where the compositions are support structures for immobilizing molecular systems to be detected by measuring emitted fluorescent light from the immobilized molecular systems. The surface compositions include a substrate, an optional functionalized layer and an absorption layer upon which molecules, molecular complexes or molecular assemblies are immobilized, where the functionalized layer comprises a functionalizing agent such as a silanizing agent and the absorption layer comprises an absorbent such as streptavidin or other proteins used to bind bio-molecules and where the substrate is transparent to electromagnetic radiation within a given frequency range or region of the electromagnetic spectrum. The absorption layer can comprise any molecule such as a protein having an affinity for the substrate or functionalized substrate, having low fluorescent or phosphorescent properties within the given frequency range and having an affinity for molecular systems (molecules, molecular complexes or molecular assemblies) to be analyzed such as sequencing complexes. After the absorption layer is formed on the substrate or functionalized substrate, molecular systems can be immobilized on the surface, such as sequencing complexes that include a fluorescent dye or fluorophore.

The present invention in one embodiment relates to a composition including a substrate, transparent within a desired range of frequencies of electromagnetic radiation, and an absorption layer absorbed on the substrate.

The present invention in one embodiment relates to a composition including a substrate, transparent within a desired range of frequencies of electromagnetic radiation, a functionalized layer and an absorption layer absorbed on the functionalized layer.

The present invention in one embodiment relates to a composition including a transparent inorganic oxide substrate, transparent within a desired range of frequencies of electromagnetic radiation, a functionalized layer and an absorption layer absorbed on the functionalized layer.

The present invention in another embodiment relates to a composition including a transparent substrate, transparent within a desired range of frequencies of electromagnetic radiation, optionally having functionalized surface, an absorption layer absorbed on the substrate or the functionalized surface and a plurality of molecules, molecular complexes or molecular assemblies immobilized thereon, where a majority of the molecules, complexes or assemblies are isolated from each other and each molecule, complex or assembly includes a first label. By majority, the inventors mean that at least 50% of the molecules, complexes or assemblies include the first label. In certain embodiments, the majority means at least 55%, at least 60%, at least 65%, at least 70%, at least 75%, at least 80%, at least 85%, at least 90%, at least 95%, at least 99%, or above 99% of the molecules, complexes or assemblies include the first label. The compositions can also include a second molecule, molecular complex, or molecular assembly bearing a second label, where the two labels are designed to interact resulting in a change in a detectable property of one or both of the labels. The type of label-label interaction can be: (1) the formation of a donor-acceptor pair, (2) the formation of an excimers, (3) the formation of a fluorophore-quencher pair, (4) the formation of a reaction product or (5) any other label-label interaction that results in a detectable change in a detectable property of one or both of the labels. Such detectable properties can include changes in one or both of the labels absorption spectra in one or more regions of the electromagnetic spectrum, transmission spectra in one or more regions of the electromagnetic spectrum, nuclear magnetic resonance properties, fluorescent properties, phosphorescent properties, or similar detectable properties. The fluorescent properties can derive from traditional fluorescence or from luminescense or fluorescence resonance energy transfer resulting in acceptor fluorescent light emission after receiving energy from its electronically excited donor.

The present invention in another embodiment relates to a composition including a transparent substrate, transparent within a desired range of frequencies of electromagnetic radiation, having silane functionalized surface, an absorption layer absorbed on the functionalized surface and a plurality of sequencing complexes, including a polymerizing agent, a primer and an unknown nucleic acid template, immobilized thereon, where a majority of the complexes are isolated from each other and each complex includes a donor-dye. The composition can further include a plurality of nucleotide types, deoxynucleotide triphosphate types (dNTP types), for the polymerizing agent, at least one nucleotide bearing an acceptor-dye to form a plurality of sequencing complexes or assemblies.

The present invention in another embodiment relates to a method for increasing detectability of a detectable property of immobilized molecules, molecular complexes and/or molecular assemblies, where the method includes the step of providing a composition including a transparent substrate, transparent within a desired range of frequencies of electromagnetic radiation, having a silane functionalized surface, an absorption layer absorbed on the functionalized surface, and a plurality of molecules, molecular complexes or molecular assemblies immobilized thereon, where a majority of the molecules, complexes or assemblies are isolated from each other and each molecule, complex or assembly includes a first label. The term majority means that at least 50%, 55%, 60%, 65%, 70%, 75%, 80%, 85%, 90%, 95%, 99% or above 99% of the molecules, complexes or assemblies are isolated. A second composition includes a second molecule, molecular complex, or molecular assembly bearing a second label, where the two labels are designed to interact resulting in a change in a detectable property of one or both of the labels, when the two compositions are brought into contract with each other. The type of label-label interaction can be: (1) the formation of a donor-acceptor pair, (2) the formation of an excimers, (3) the formation of a fluorophore-quencher pair, (4) the formation of a reaction product or (5) any other label-label interaction that results in a detectable change in a detectable property of one or both of the labels. Such changes in detectable properties can include changes in one or both of the labels absorption spectra in one or more regions of the electromagnetic spectrum, changes in one or both labels transmission spectra in one or more regions of the electromagnetic spectrum, changes in nuclear magnetic resonance properties of one or both of the labels, changes in fluorescent properties of one or both of the labels, changes in phosphorescent properties of one or both of the labels, changes in any other detectable properties of one or both of the labels or any other interaction that would result in a detectable change in a detectable property. The changes in fluorescent properties can derive from traditional fluorescence or from luminescense or fluorescence resonance energy transfer resulting in acceptor fluorescent light emission after receiving energy from an electronically excited donor. The method can include monitoring changes to both the acceptor emission signal and the donor emission signal. The method also includes the step of subjecting the compositions to a detection methodology for detecting changes in one or more detectable properties of one or both of the labels before, during and/or after label interaction. The method can further include the step of detecting the changes in detectable properties corresponding to one or a series of interaction events. The method can further include the step of relating the changes in detectable properties to the interaction events. The method can also include detecting changes in detectable properties of a donor and multiple acceptors, in certain embodiments up to four different dyes, where the acceptors interact sequentially with the donor.

The present invention in another embodiment relates to a method for delaying dye or fluorophore fluorescent permanent photo-bleaching or dye deactivation and improving dye or fluorophore fluorescent properties such as reduced blinking, improved fluorescent spectra characteristics, etc. The method includes the step of providing support composition comprising a transparent substrate, transparent within a desired range of frequencies of electromagnetic radiation, having silane functionalized surface, an absorption layer absorbed on the functionalized surface, and a plurality of sequencing complexes, including a polymerizing agent, a primer and an unknown nucleic acid template, immobilized thereon, where a majority of the complexes are isolated from the other and each complex includes a donor dye. The method also includes the step contacting the support composition with second composition including a plurality of nucleotide types, deoxynucleotide triphosphate types (dNTP types), for the polymerizing agent to form sequencing compositions, where at least one nucleotide includes an acceptor-dye. The method also includes the step of irradiating the sequencing compositions with light of a frequency to photo-excite the donor-dyes, while leaving the acceptor-dyes substantially (at least 95% of the acceptors in the ground state) in their ground state or non-photo-excited state. The method also includes the step of measuring acceptor fluorescence before, during and after fluorescent resonance energy transfer from an excited donor and donor fluorescence before, during and/or after fluorescence resonance energy transfer. The method can also include the step of relating the measured fluorescent light to a sequence of acceptor labeled dNTP incorporation events. The method can also include measuring donor fluorescence before, during and/or after fluorescent resonance energy transfer from an excited donor and donor fluorescence before, during and/or after fluorescence resonance energy transfer.

The present invention in another embodiment relates to substrates having formed thereon a thin layer of a group VIII metal, noble metal, alloy thereof and mixtures or combinations thereof. Exemplary metals from the periodic table of elements including, without limitation, Fe (iron), Co (cobalt), Ni (nickel), Ru (ruthenium), Rh (rhodium), Pd (palladium), Os (osmium), Ir (iridium), Pt (platinum), Cu (copper), Ag (silver), Au (gold), or alloys thereof and mixtures or combinations thereof. While group VIII metals are generally preferred, any thin metallic layer can be used provided that the metal does not interfere with the molecular reaction being monitored. The metal layer, which can be a monolayer thick, several monolayers thick up to many monolayers. In certain embodiments, the layer can have a thickness between about 1 nm to about 1 mm, provided that the metal layer is transparent to the wavelengths of light being used to excited and detect the molecular reaction. The metal layer can then be treated with a desired molecule having a head group and a tail group and a linking group in between (A¹-L-A², where A¹ is the head group, L is the linking group and A² is the tail group). The tail group A² is capable of reacting with metal atoms on the metal layer on the surface and the molecule is capable of forming a self-assembly monolayer on the metal layer on the substrate surface. The head groups A² groups can all be the same and are capable of imparting desired characteristics to a solvent accessible surface of the composition. The term solvent accessible means portion of the surface of the composition that include a substrate, a metal layer and a self-assembly monolayer that is accessible to water or molecules dissolved in an aqueous solution or other solvent systems if the compositions are used in non-aqueous solvent systems. The head groups A² can also be different, where some of the A² groups impart desired surface characteristics, while other groups are designed to allow attachment of molecules thereto via a chemical reaction and/or a physical association. The A¹ group are generally —SH, —NH₂, —CSS⁻, or any other groups known to react with or have an affinity for binding to a metal surface. The A² group can be any group mentioned above in connection with silanes or any other group that to which a molecule, molecular complex or molecular assembly can be attached.

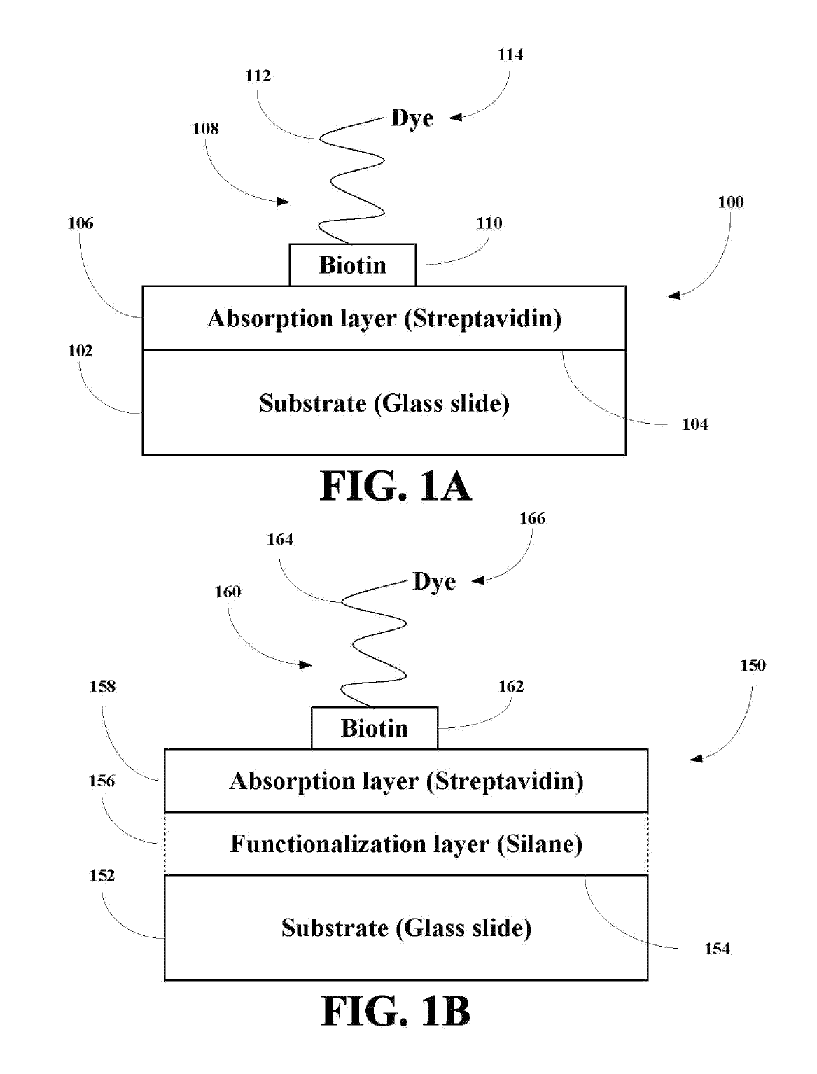

Pictorial Representation of a Surface Composition of this Invention Referring now to FIG. 1A, a first illustrative example of a composition, generally 100, of this invention is shown to include a substrate 102 having a top surface 104. The composition 100 also includes an absorption layer 106 formed on the surface 104. The composition 100 also includes an immobilized molecule 108 comprising a biotin tail 110, a linker 112 and a dye head 114. This composition can be used to test substrate, absorption layer, and linker type and structure on dye persistence. The substrate with the absorption layer can also be used to immobilize pre-sequencing complexes thereon, where each pre-sequencing complex includes a polymerizing agent and a primer/template duplex, where at least one component of the complex includes a dye. Generally, the pre-sequencing complexes are immobilized on the composition by immobilizing one of the components and then forming the remaining components of the complex on the immobilized component, e.g., immobilize the primer, add the template to form primer/template duplexes, then add the polymerizing agent to form the pre-sequencing complexes. These resulting substrates can be used to test substrate, absorption layer and linker type and structure on dye persistence for such pre-sequencing complex. The resulting substrates can also be contacted with an extension solution including nucleotides or dNTPs for the polymerization agent, where at least one nucleotide or dNTP includes an acceptor-dye adapted to undergo FRET with an excited donor-dye for detecting incorporations events based on FRET signatures.

Referring now to FIG. 1B, a second exemplary example of a composition, generally 150, of this invention is shown to include a substrate 152 having a top surface 154. The composition 150 also includes a functionalized layer 156 formed on the surface 154 and an absorption layer 158 formed on the functionalized layer 156. The composition 150 also includes an immobilized molecule 160 comprising a biotin tail 162, a linker 164 and a dye head 166. This composition can be also used to test substrate, absorption layer, and linker type and structure on dye persistence. The substrate with the absorption layer can also be used to immobilize pre-sequencing complexes thereon, where each pre-sequencing complex includes a polymerizing agent and a primer/template duplex, where at least one component of the complex includes a dye. These resulting substrates can be used to test substrate, absorption layer and linker type and structure on dye persistence for such pre-sequencing complex. The resulting substrates can also be contacted with an extension solution including nucleotides or dNTPs for the polymerization agent, where at least one nucleotide or dNTP includes an acceptor-dye adapted to undergo FRET with an excited donor-dye for detecting incorporations events based on FRET signatures.

Suitable Reagents

Suitable substrates include, without limitation: (1) inorganic oxides such as silica, alumina, glass, quartz, sapphire, indium tin oxide ITO, ceramics, or the like, (2) metals such as the noble metals including copper, nickel, cobalt, iron, gold, silver, platinum, ruthenium, rhodium, iridium, palladium, or alloys thereof, (3) plastics or polymers, such as polyethylene, polypropylene, polystyrene, or other structural plastics or (4) composites of any of the afore mentioned materials or mixtures or combinations thereof. These substrates can used directly to support an adsorption layer such as a protein like a streptavidin layer or the substrate can be functionalized with a functionalizing agent or the substrate can be functionalized with a functionalizing agent onto to which an absorption layer is added. In the case of metals, the functionalization is generally performed using thiols. For plastics, the functionalization is generally via grafting a functionalizing group onto the plastic surface.

Suitable absorbent include, without limitation: (1) polymers such as polyamides, polyimides, polyesters, polyalkyleneoxides, polyvinlychlorides, ionomers, hydrogels, or the like, or mixtures or combinations thereof, (2) proteins such as streptavidin, neutravidin, avidin, staphylococcal Proteins A and G available from Rockland, Incorporated, other proteins or polypeptides capable of absorbing or binding molecules, molecular complexes or molecular assemblies, or the like, or mixtures or combinations thereof, or (3) other bio-molecules capable of absorbing molecules or molecular assemblies including a label having a detectable property or mixtures or combinations thereof.

Suitable silanizing agents for inorganic oxide and especially glass surfaces include, without limitation, any silanizing agent of the general formula Z-R-SiA¹A²A³, where Z is a head group, R is a linking group, and A¹, A² and A³ at least one of these group being hydrolysable or displaceable or mixtures or combinations thereof. The Z groups are selected from the group consisting of, but not limited to, alkyl groups, aryl groups, alkaryl groups, aralkyl groups, halogenated alkyl groups, halogenated aryl groups, halogenated alkaryl groups, halogenated aralkyl groups, nitrogen-containing groups such as cyclic or acyclic amines, cyclic or acyclic amide, or the like, oxygen-containing groups such as alkoxides (groups derived from an alcohol, i.e., ROH, where R is a carbyl group—carbon, hydrogen, heteroatoms, etc. —a general carbon containing group), acyclic ethers, cyclic ethers including epoxides, acid, cyclic or acyclic anhydrides, acyclic or cyclic esters, saccharides, or the like, sulfur-containing groups such as thiols, disulfides, polysulfides, thioacids, carbamates, thio esters or the like, phosphorus-containing groups such as phosphates, phosphate esters, phosphites and phosphite esters, or the like, boron-containing groups such as boranes, carboranes, borates, or the like, alkyl, aryl, aralkyl or alkaryl group where one or more of the carbon atoms in any has been replaced by a hetero atom selected from the group consisting of oxygen, sulfur, nitrogen in the form of an amide, boron, or mixtures thereof, other similar groups and mixtures or combinations thereof. R is an alkenyl group having between about 1 and about 30 carbon atoms, where one or more of the carbon atoms can be replaced by a hetero atom selected from the group consisting of oxygen, sulfur, nitrogen in the form of an amide, boron in the form of a borane, carborane, or the like, or mixtures thereof and one or more of the hydrogen atoms can be replace by a halogen selected from the group consisting of fluorine, chlorine, bromine, iodine or mixtures thereof. A¹, A² and A³ are the same or different and at least one is displaceable by an OH group on the substrate surface such as an SiOH, an AlOH or other reactive OH group on the substrate surface.

Exemplary examples of amines include, without limitation, NH₂, NR¹H, and NR¹R², where R¹ and R² are the same or different and are an alkyl group, an aryl group, an alkaryl group or an aralkyl group having about 1 to about 40 carbon atoms, where one or more of the carbon atoms can be replaced by a hetero atom selected from the group consisting of oxygen, sulfur, nitrogen in the form of an amide, boron, or mixtures thereof and one or more of the hydrogen atoms can be replace by a halogen selected from the group consisting of fluorine, chlorine, bromine, iodine or mixtures thereof. The alkyl groups can be linear, branched, cyclic or aromatic or mixtures thereof.

Exemplary examples of aromatic nitrogen-containing compounds include, without limitation, pyridine, pyrrole, indole, isoindole, imidazole, benzimdiazole, purine, pyrazole, indazole, oxazole, benzoxazole, thiazole, benzothiazole, quinoline, isoquinoline, pyrazine, quinozaline, acridine, pyrimidine, quinazoline, pyridazine, cinnoline or mixtures thereof.

Exemplary examples of cyclic ethers include, without limitation, epoxides, furans, or the like.

Exemplary examples of alkoxides include, without limitation, groups of the general formula OR³, where R³ is an alkyl group, an aryl group, an alkaryl group or an aralkyl group having from about 1 about to about 40 carbon atoms where one or more of the carbon atoms can be replaced by a hetero atom selected from the group consisting of oxygen, sulfur, nitrogen in the form of an amide, boron, or mixtures thereof and one or more of the hydrogen atoms can be replace by a halogen selected from the group consisting of fluorine, chlorine, bromine, iodine or mixtures thereof.

Exemplary examples of esters include, without limitation, groups of the general formula COOR⁴, where R⁴ is an alkyl group, an aryl group, an alkaryl group or an aralkyl group having from about 1 about to about 40 carbon atoms where one or more of the carbon atoms can be replaced by a hetero atom selected from the group consisting of oxygen, sulfur, nitrogen in the form of an amide, boron, or mixtures thereof and one or more of the hydrogen atoms can be replace by a halogen selected from the group consisting of fluorine, chlorine, bromine, iodine or mixtures thereof.

Exemplary examples of sulfides include, without limitation, groups of the general formula SR⁵, where R⁵ is an alkyl group, an aryl group, an alkaryl group or an aralkyl group having from about 1 about to about 40 carbon atoms where one or more of the carbon atoms can be replaced by a hetero atom selected from the group consisting of oxygen, sulfur, nitrogen in the form of an amide, boron, or mixtures thereof and one or more of the hydrogen atoms can be replace by a halogen selected from the group consisting of fluorine, chlorine, bromine, iodine or mixtures thereof.

Exemplary examples of displaceable A groups include, without limitation, groups of the general formula OR⁶, where R⁶ is an alkyl group, an aryl group, an alkaryl group or an aralkyl group having from about 1 about to about 4 carbon atoms or mixtures or combinations thereof.

Suitable nucleotides or dNTPs including, without limitation, naturally occurring nucleotides (e.g., ATP, GTP, TTP, UTP, CTP, DATP, dGTP, dTTP, dUTP, dCTP, synthetic analogs), precursors for each nucleotide, non-naturally occurring nucleotides and their precursors or any other molecule that can be incorporated into a growing polymer chain by a given polymerase. Additionally, amino acids (natural or synthetic) for protein or protein analog synthesis, mono saccharides for carbohydrate synthesis or other monomeric syntheses. Suitable nucleotides or dNTPs include any of the above species including one or more dye bonded directly to a site of the nucleotide or dNTP or through a linking agent or one or more moieties designed to alter incorporation efficiencies or incorporation dynamics.

Suitable polymerizing agents include, without limitation, any polymerizing agent that polymerizes monomers relative to a specific template such as a DNA or RNA polymerase, reverse transcriptase, or the like or that polymerizes monomers in a step-wise fashion.

Suitable polymerases for use in this invention include, without limitation, any polymerase that can be isolated from its host in sufficient amounts for purification and use and/or genetically engineered into other organisms for expression, isolation and purification in amounts sufficient for use in this invention such as DNA or RNA polymerases that polymerize DNA, RNA or mixed sequences, into extended nucleic acid polymers. Preferred polymerases for use in this invention include mutants or mutated variants of native polymerases where the mutants have one or more amino acids replaced by amino acids amenable to attaching an atomic or molecular tag, which have a detectable property. Exemplary DNA polymerases include, without limitation, HIV1-Reverse Transcriptase using either RNA or DNA templates, DNA pol I from T. aquaticus or E. coli, Bateriophage T4 DNA pol, T7 DNA pol, Phi 29, or the like. Exemplary RNA polymerases include, without limitation, T7 RNA polymerase or the like.

Suitable other labels include, without limitation, with nmr active groups, labels with spectral features that can be easily identified by spectroscopic techniques such as IR, near IR, far IR, visible UV, far UV, soft-X-ray, X-ray, neutron activation analysis, or the like.

Suitable labels or dyes or fluorophores include, without limitation, any atomic element amenable to attachment to a specific site in a polymerizing agent or dNTP, especially fluorescent dyes such as d-Rhodamine acceptor dyes including dichloro[R110], dichloro[R6G], dichloro[TAMRA], dichloro[ROX] or the like, fluorescein donor dye including fluorescein, 6-FAM, or the like; Acridine including Acridine orange, Acridine yellow, Proflavin, or the like; Aromatic Hydrocarbon including 2-Methylbenzoxazole, Ethyl p-dimethylaminobenzoate, Phenol, Pyrrole, benzene, toluene, or the like; Arylmethine Dyes including Auramine O, Crystal violet, Crystal violet, Malachite Green or the like; Coumarin dyes including 7-Methoxycoumarin-4-acetic acid, Coumarin 1, Coumarin 30, Coumarin 314, Coumarin 343, Coumarin 6 or the like; Cyanine Dye including 1,1′-diethyl-2,2′-cyanine iodide, Cryptocyanine, Indocarbocyanine (C3) dye, Indodicarbocyanine (C5) dye, Indotricarbocyanine (C7) dye, Oxacarbocyanine (C3) dye, Oxadicarbocyanine (C5) dye, Oxatricarbocyanine (C7) dye, Pinacyanol iodide, Stains all, Thiacarbocyanine (C3) dye, Thiacarbocyanine (C3) dye, Thiadicarbocyanine (C5) dye, Thiatricarbocyanine (C7) dye, or the like; Dipyrrin dyes including N,N′-Difluoroboryl-1,9-dimethyl-5-(4-iodophenyl)-dipyrrin, N,N′-Difluoroboryl-1,9-dimethyl-5-[(4-(2-trimethylsilylethynyl), N,N′-Difluoroboryl-1,9-dimethyl-5-phenydipyrrin, or the like; Merocyanines including 4-(dicyanomethylene)-2-methyl-6-(p-dimethylaminostyryl)-4H-pyran (DCM), acetonitrile, 4-(dicyanomethylene)-2-methyl-6-(p-dimethylaminostyryl)-4H-pyran (DCM), 4-Dimethylamino-4′-nitrostilbene, Merocyanine 540, or the like; Miscellaneous Dye including 4′,6-Diamidino-2-phenylindole (DAPI), 4′,6-Diamidino-2-phenylindole (DAPI), 7-Benzylamino-4-nitrobenz-2-oxa-1,3-diazole, Dansyl glycine, Dansyl glycine, Hoechst 33258, Hoechst 33258, Lucifer yellow CH, Piroxicam, Quinine sulfate, Quinine sulfate, Squarylium dye III, or the like; Oligophenylenes including 2,5-Diphenyloxazole (PPO), Biphenyl, POPOP, p-Quaterphenyl, p-Terphenyl, or the like; Oxazines including Cresyl violet perchlorate, Nile Blue, Nile Red, Nile blue, Oxazine 1, Oxazine 170, or the like; Polycyclic Aromatic Hydrocarbons including 9,10-Bis(phenylethynyl)anthracene, 9,10-Diphenylanthracene, Anthracene, Naphthalene, Perylene, Pyrene, or the like; polyene/polyynes including 1,2-diphenylacetylene, 1,4-diphenylbutadiene, 1,4-diphenylbutadiyne, 1,6-Diphenylhexatriene, Beta-carotene, Stilbene, or the like; Redox-active Chromophores including Anthraquinone, Azobenzene, Benzoquinone, Ferrocene, Riboflavin, Tris(2,2′-bipyridyl)ruthenium(II), Tetrapyrrole, Bilirubin, Chlorophyll a, Chlorophyll a, Chlorophyll b, Diprotonated-tetraphenylporphyrin, Hematin, Magnesium octaethylporphyrin, Magnesium octaethylporphyrin (MgOEP), Magnesium phthalocyanine (MgPc), Magnesium phthalocyanine (MgPc), Magnesium tetramesitylporphyrin (MgTMP), Magnesium tetraphenylporphyrin (MgTPP), Octaethylporphyrin, Phthalocyanine (Pc), Porphin, Tetra-t-butylazaporphine, Tetra-t-butylnaphthalocyanine, Tetrakis(2,6-dichlorophenyl)porphyrin, Tetrakis(o-aminophenyl)porphyrin, Tetramesitylporphyrin (TMP), Tetraphenylporphyrin (TPP), Vitamin B12, Zinc octaethylporphyrin (ZnOEP), Zinc phthalocyanine (ZnPc), Zinc tetramesitylporphyrin (ZnTMP), Zinc tetramesitylporphyrin radical cation, Zinc tetraphenylporphyrin (ZnTPP), or the like; Xanthenes including Eosin Y, Fluorescein, Fluorescein, Rhodamine 123, Rhodamine 6G, Rhodamine B, Rose bengal, Sulforhodamine 101, or the like; or mixtures or combination thereof or synthetic derivatives thereof or FRET fluorophore-quencher pairs including DLO-FB1 (5′-FAM/3′-BHQ-1) DLO-TEB1 (5′-TET/3′-BHQ-1), DLO-JB 1 (5′-JOE/3′-BHQ-1), DLO-HB 1 (5′-HEX/3′-BHQ-1), DL0-C3B2 (5′-Cy3/3′-BHQ-2), DLO-TAB2 (5′-TAMRA/3′-BHQ-2), DLO-RB2 (5′-ROX/3′-BHQ-2), DL0-C5B3 (5′-Cy5/3′-BHQ-3), DL0-C55B3 (5′-Cy5.5/3′-BHQ-3), MBO-FB1 (5′-FAM/3′-BHQ-1), MBO-TEB1 (5′-TET/3′-BHQ-1), MBO-JB1 (5′-JOE/3′-BHQ-1), MBO-HB1 (5′-HEX/3′-BHQ-1), MBO-C3B2 (5′-Cy3/3′-BHQ-2), MBO-TAB2 (5′-TAMRA/3′-BHQ-2), MBO-RB2 (5′-ROX/3′-BHQ-2); MBO-C5B3 (5′-Cy5/3′-BHQ-3), MBO-C55B3 (5′-Cy5.5/3′-BHQ-3) or similar FRET pairs available from Biosearch Technologies, Inc. of Novato, Calif. or any other fluorescent donor or acceptor. Suitable labels also include quantum dots, or other persistent nano-structured fluorophores.

### Experimental Section of the Inventions

Glass Preparation

Glass cover slips having a thickness between 0.16-0.19 mm are put in a base bath overnight and are then cleaned with 2% Micro-90 for 60 minutes with sonication and heat. The slips were then boiled in an RCA solution for a combined treatment time of 60 minutes comprising two 30 minute treatments. Although the standard RCA solution that comprises H₂O: 30% NH₄OH: 30% H₂O₂ in a 6:4:1 ratio can be used herein, we have used a modified RCA solution that comprises H₂O: 30% NH₄OH: 30% H₂O₂ in a 8:1.1:0.9 ratio. It should be recognized that other ratio of water, ammonium hydroxide and hydrogen peroxide can be used as well. Alternatively, the substrate or a surface thereof can be cleaned using any known or yet developed method that removes undesirable fluorophore or reduces natural fluorescence and produces a surface suitable for subsequent modification. An example of an alternative cleaning method includes plasma treatment, electron or ion etching or the like.

Functionalization

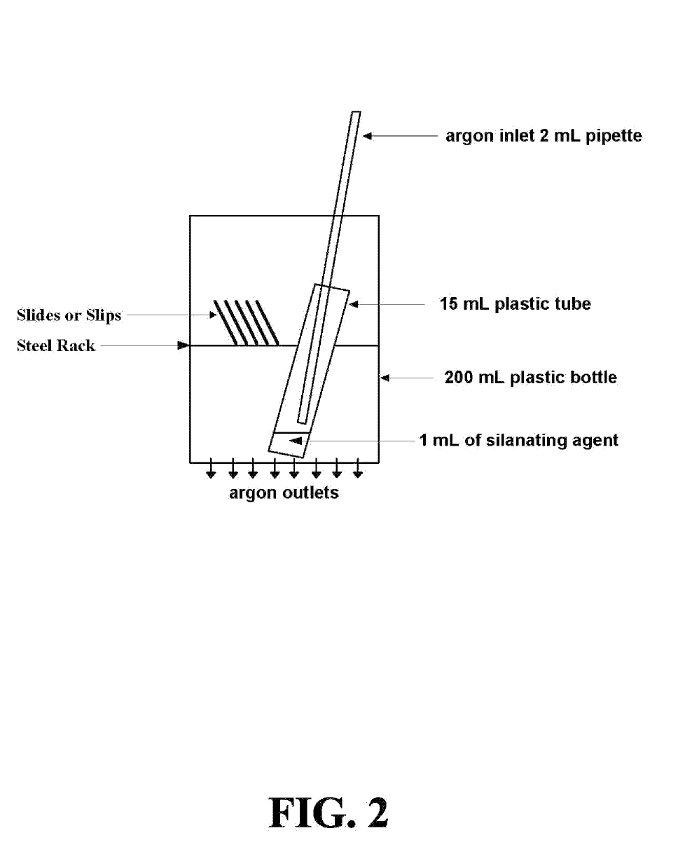

Functionalization was achieved using a new functionalization technique and apparatus. This new technique permits a more uniform functionalization and is basically a vapor functionalization technique and apparatus. The technique is shown pictorially in FIG. 2 for a silanizing agent, but any functionalizing agent can be placed in the tube. The apparatus includes a tube placed inside a bottle. A distal end of a pipette is placed inside the tube. Substrates are placed in the bottle on a rack so that each can be exposed to a vapor environment generated by a carrier gas passing over or through a functionalizing agent placed in the tube. The bottle includes a top having a pipette aperture and a plurality of outlet apertures in the bottom of the bottle, where the outlet apertures are designed to maintain a desired gas pressure in the bottle. A carrier gas is introduced into the tube via the pipette producing a vapor stream including the functionalizing agent. The vapor stream, including the functionalizing agent, then contacts the substrate placed on the rack in the bottle, thereby functionalizing the substrate.

In the present experiment, silanization was carried out using an inert gas stream such as helium, neon, nitrogen, argon, hydrogen, low molecular weight alkanes or mixture thereof, stream blown into or onto a pure silanizing agent or silane such as an epoxy silane. The inert gas stream causes evaporation or vapor entrainment of the silanizing agent. The vapor containing the silanizing agent then contacts the cleaned glass slides resulting in a vapor deposition of the silanizing agent onto the surfaces of the cleaned glass slips. The vapor deposition was carried out at room temperature in the inert gas flow. By avoiding silane aqueous solutions and high temperatures, we were able to obtain clean silanized surfaces having a more uniform silanization. The resulting silanized slip surface shows no multi-layers or aggregates which are generally formed when aqueous silanizing solution or high temperature vacuum deposition techniques are used. It should be recognized that other silanizing methods can be used include vacuum vapor deposition, or other reduced pressure silanizing methods.

Silanization

### EXAMPLE 1

This example illustrates the preparation of a 3-aminopropyl trimethoxysilane functionalized glass slip.

1 mL of 3-aminopropyl triethoxysilane (from Sigma-Aldrich) was added into a 15 mL plastic tube that was placed into a 200 mL plastic bottle. The bottle was then capped and a 2 mL plastic pipette was passed through an aperture in the cap so that its distal end was inside the tube containing the 3-aminopropyl triethoxysilane. An argon supply tube was attached to an argon supply and to a proximal end of the pipette and argon was passed through the 2 mL plastic pipette into the tube with containing the 3-aminopropyl triethoxysilane to increase evaporation of the 3-aminopropyl triethoxysilane from the tube. The argon containing the 3-aminopropyl triethoxysilane escaped through the holes in the bottom of the plastic bottle. 5 cover slips were placed in the plastic bottle in a steel rack. Argon was flowed through the bottle for 30 minutes at room temperature. The slides were then washed with ethanol, and kept dry.

### EXAMPLE 2

This example illustrates the preparation of a 3-glycidoxypropyl trimethoxysilane functionalized glass slip.

The procedure of Example 1 was repeated, but the 3-aminopropyl trimethoxysilane was replaced with 1 mL of 3-glycidoxypropyl trimethoxysilane (from Acros Organics).

### EXAMPLE 3

This example illustrates the preparation of a 3-cyanopropyl triethoxysilane functionalized glass slip.

The procedure of Example 1 was repeated, but the 3-aminopropyl triethoxysilane was replaced with 1 mL of 3-cyanopropyl triethoxysilane (from Sigma-Aldrich).

### EXAMPLE 4

This example illustrates the preparation of a 3-mercaptopropyl triethoxysilane functionalized glass slip.

The procedure of Example 1 was repeated, but the 3-aminopropyl triethoxysilane was replaced with 1 mL of 3-mercaptopropyl triethoxysilane (from Sigma-Aldrich).

Streptavidin Adsorption

### EXAMPLE 5-8

These examples illustrate the preparation of a streptavidin absorption layer on the surfaces of the slips of Examples 1-4. However, neutravidin or avidin can be used in exactly the same way streptavidin save that the surface would be neutravidin or avidin.

A solution of streptavidin (1 mg/mL) was placed onto a bare glass slip surface or glass slip surface of Examples 1-4 in a buffer designed to maximize streptavidin absorption onto the functionalized layer to form streptavidin absorbed slips corresponding to Examples 5-8, respectively. For functionalized slips of Example 2, streptavidin absorption was performed using streptavidin in 100 mM citric buffer at pH 4.4. For bare glass slips, streptavidin absorption was performed using streptavidin in PBS at pH 7.0. Slips were kept at 4° C. overnight and then washed with Tris buffer for 30 minutes at room temperature. Slips were kept in Tris buffer until used.

On Surface Post Extension Detection Experimental Protocol

After streptavidin was adsorbed on the surface of the slips of Examples 1-4, the following steps were performed to immobilize primer-template duplexes on the slips:
1. A appropriate primer-template duplex was diluted in 1×KB buffer, where the primer includes a donor dye. The KB buffer comprises 50 mM Tris pH 7.2, 10 mM MgSO₄, and 0.1 mM DTT (Dithiothreitol).
2. The duplexes were immobilized on a slip of Example 1-4 by contacting the surface with a solution having a concentration of about 4-15 pM duplexes for 10 minutes at room temperature to achieve immobilized duplexes on the slip surface.
3. The slip with the immobilized duplexes was then washed one time in a jar for 5 minutes in Tris (tris-hydroxymethylaminomethane) buffer.
4. The slip with the immobilized duplexes was then washed for 5 minutes in an open chamber one time with KBP buffer. KBP buffer comprises 1× Klenow buffer+Na₂HPO₄ working concentration: 50 mM Tris pH 7.2, 10 mM MgSO₄, 0.1 mM DTT, 10 mM Na₂HPO₄.
5. The slip with the immobilized duplexes was then washed five times with Denhardt's solution and 200 μg/mL of t-RNA in 1×KB buffer.
6. The wash solution was then replaced with 1×KB buffer.
7. This buffer was discarded, and an extension solution including A1610-γ-dGTP+dCTP-Cy5 base labeled at 0.5 μM and VKE at 147 nM or DOA (DOA is an polymerase enzyme variant that is about 1000 times less active than the wild type enzyme and is used as a control for determining labeled enzyme) control solution including A1610-γ-dGTP+dCTP-Cy5 base labeled at 0.5 μM and DOA1 at 147 nM in 1×KB with 5×Denhardt's solution, 200 μg/ml of t-RNA, and MnCl₂ at 2.5 mM was added to a volume of 225 μL to mimic real time experiments. The labeled γ-dNTPs are available from VisiGen Biotechnologies, Inc.
8. The slip with the immobilized duplexes is then incubated in a chamber for 10 minutes at room temperature.
9. The extension or DOA solutions were discarded. The slip with the immobilized duplexes was drained and immediately put in a jar for 1 minute containing TrisBE buffer to quench the reaction and wash off the excess mix. TrisBE buffer comprises TrisB+EDTA working concentration: 10 mM Tris, pH 8.0, 10 mM NaCl, 10 nM EDTA.
10. The slip with the immobilized duplexes was drained, mounted on the steel plate to be placed on the stage, 225 μL of 1×KB were added
11. Data was collected at 25 ms exposure using the Argon laser. 10 streams including 1000 frames per stream of data were collected for each slip with the immobilized duplexes.
   Real Time on Surface Experimental Protocol

After streptavidin was adsorbed on the surface of the slips of Examples 1-4, the following steps were performed to immobilize primer-template duplexes and run sequencing experiments on the slips:
1. A appropriate primer-template duplex was diluted in 1×KB buffer, where the primer includes a donor dye.
2. The duplexes were immobilized on a slip of Example 1-4 by contacting the solution having a concentration of about of 4-15 pM duplexes for 10 minutes at room temperature to achieve immobilized duplexes on the slip surface.
3. The slip with the immobilized duplexes was washed 1×Tris B in a jar for 5 minutes.
4. Then the slip with the immobilized duplexes was washed for 5 minutes in an open chamber with 1×KBP.
5. The washed slip with the immobilized duplexes was then treated with 5×Denhardt's solution and 200 μg/mL of tRNA in 1×KB.
6. The treated slip was then drained and 100 μL of 1×KB was added.
7. The resulting slip was then taken to a dark room including the detection system for detection.
8. Buffer was removed from the slip and the slip was placed on the steel plate on a microscope stage of the detection system. Immediately after placing the slip on the plate, 225 μL of a control solution including A1610-γ-dGTP+dCTP-Cy5 base labeled at a concentration of 0.5 μM; DOA1 at a concentration of 147 nM was added to the slip in 1×KBMn or an extension solution including A1610-γ-dGTP+dCTP-Cy5 base labeled at a concentration of 0.5 μM; VKE a concentration of 147 nM With 5×Denhardt's solution, 200 μg/ml of tRNA and MnCl₂ at a final concentration of 2.5 mM was added to the slip. The labeled γ-dNTPs are available from VisiGen Biotechnologies, Inc.
9. Data were collected at 25 ms exposure using the Argon laser. 10 streams including 1000 frames per stream of data were collected for each slip with the immobilized duplexes.

In the prior art, it was reported that streptavidin formed direct chemical attachments to an epoxy silane modified surface (Kusnezov W., Jacob A., Walijew A., Diehl F., Hoheisel J. D. Antibody micro-arrays: An evaluation of production parameters, Proteomics 2003, 3, 254-264). Moreover, the prior art also reported that pH did not have any effect on the attachment of streptavidin to glass surfaces—treated or untreated. To determine whether the surfaces of this invention behaved similarly, we studied streptavidin binding to the bare or virgin glass and epoxy-silane modified glass. The surfaces were treated with biotinylated primer including a donor-dye. The surfaces were then observed in a detection system to determine fluorescent light emitted from the donor or from the donor and one or more acceptors capable of undergoing FRET with the donor. The results are summarized in Table I.

TABLE I
Streptavidin Binding

| | number of spots on | number of spots |
|---|---|---|
| pH | epoxy-silane modified glass | on the glass |
| 11.8 | 175, 204 | |
| 11.5 | 138, 147 | |
| 9.8 | 109, 132 | |
| 8.0 | 160, 240 | |
| 7.2 | 230, 250 | 678, 712 |
| water | 268, 346, 367 | 411, 480 |
| 5.5 | 383, 387 | 480, 535 |
| 4.4 | 700, 794 | 160, 180 |

Surprisingly and unexpectedly, streptavidin binding reached a maximum at pH 7.2 for the glass and maximum at pH 4.4 for the epoxy-silane modified glass. While not wanting to be bound by any theory or conclusion, the pH dependence of the streptavidin binding suggests that streptavidin is likely not chemically bonded to the surface, but is merely physically adsorbed to the surface.

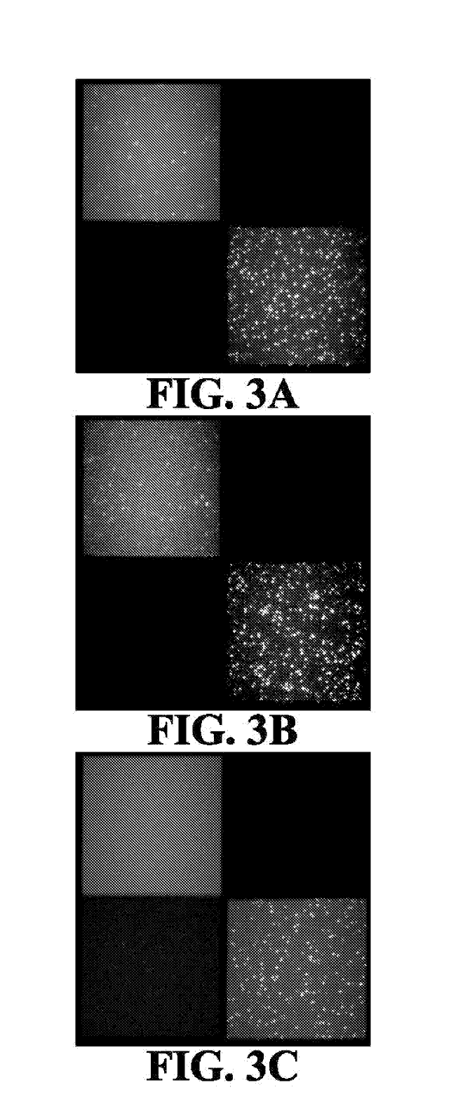

The glass and epoxy-silane modified glass were then contacted with a solution including nucleotides for the polymerizing, at least one nucleotide including an acceptor-dye. Since glass had a higher background, the epoxy-slides gave superior results as shown in FIGS. 3A&B (epoxy treated and bare glass, respectively), where post extension reactions carried out in the detection system using the epoxy-streptavidin surfaces are shown for two different data streams of the same slide. FIG. 3C shows post extension images for an enzyme with reduced catalytic activity, 1/1000 reduced activity for epoxy-streptavidin surfaces.

Another surprising and unexpected result was that average donor persistence increased by about 2.5 times when pre-sequencing complexes are immobilized on the epoxysilane modified glass surface of Example 2 as compared to a polyelectrolyte modified glass surface used as a control prepared as described in I. Braslavsky, B. Hebert, E. Kartalov, and S. R. Quake, “Sequence Information Can Be Obtained from Single Dna Molecules,” (2003) PNAS 100, 3960-3964 and in United States Patent Application Published as 20060046258, incorporated herein by reference (these surfaces were used as control surfaces). Moreover, the amount of donor blinking was also reduced. Blinking is a phenomenon where the donor dye enters into a dark state, periodically fluctuating in intensity. Furthermore, donor emission appeared to be more stable before deactivation via permanent photo-bleaching. On a chemically bound surface (through amino-biotin), average donor persistence was only 20% higher. There are a number possible explanations for this surprising increase in donor persistence. One explanation may be that ions of the control surface have a negative effect on average donor persistence. Due to the nature of illumination in this detection system using total internal reflectance fluorescence, another possibility for the observed increase in donor persistence is that the distance between the surface and a donor dye may alter the strength of the energy field in which the donor resides on this novel surface. The results of this study are shown in Table II.

TABLE II
Donor Persistence Measurements

| | Average | Average | |
|---|---|---|---|
| | Persistence | Intensity | Average |
| | (msec) | (arb. units) | Activity^{‡} |
| Epoxy (absorption) | 21457 | 261 | 0.0334 |
| Epoxy (amino biotin) | 10431 | 171 | 0.1272 |
| Control (polyelectrolyte) | 8535 | 205 | 0.2234 |

^{‡}Average Activity means Average Dark/[Dark + Excite] − the average time that the dye exhibits reduced emission divided by the sum of the time that the dye exhibits reduced emission plus the time that the dye emits detectable light

Donor persistence was also calculated using proprietary FRET analysis software from VisiGen Biotechnologies, Inc. of Houston, Tex., in several experimental conditions and the results are summarized in Table III.

TABLE III
Donor Persistence by Fretan 2.31

| | Donor Persistence |
|---|---|
| Immobilization Surface | (sec) |
| Epoxy-silanized Glass with One Streptavidin Layer | 69 |
| Glass with One Streptavidin Layer | 71 |
| Glass with Two Streptavidin Layers | 74 |
| Control - Polyelectrolyte Surface | 25 |
| Post Extension on Epoxy + Streptavidin (VKE) | 44 |

To further reduce background, commonly used capping or blocking reagents, such as a Denhardt's solution or a salmon sperm DNA solution with or without a detergent were tested. The application of a detergent such as Triton X-100, Tween 20, etc. to the epoxy silane modified glass did not reduce background. The Denhardt's and DNA solutions reduced the background significantly, although it was still above the background of a control polyelectrolyte surface. The results are summarized in Table IV.

TABLE IV
Effects of Washes and Additives on Background Intensity

| | | | | Background | Background |
|---|---|---|---|---|---|
| | Wash | Wash | Added also to | Intensity, | Intensity, |
| Surface | 5× Denhardt's | 0.1 mg/ml DNA | extension mix | Acceptor 1 | Acceptor 2 |
| Glass | N | N | N | 3386, 3505 | 2540, 2600 |
| Epoxy | N | N | N | 3337, 3647 | 2478, 2537 |
| Epoxy | Y | | | 2860, 2769 | 2413, 2464 |
| Epoxy | | Y | | 2911, 2740 | 2444, 2517 |
| Epoxy | Y | | Y | 2779, 2891 | 2429, 2493 |
| Epoxy | | Y | Y | 2616, 2716 | 2398, 2460 |
| Epoxy | +Detergent | | +Detergent | 2749, 2829 | 2476, 2525 |
| Epoxy | | +Detergent | +Detergent | 2627, 2731 | 2429, 2504 |
| PE | | | | 2550 | 2400 |

PE means polyelectrolyte surface

The Denhardt's and DNA solutions reduced the background significantly in the acceptor 1 channel, although it was still above the background on a regular polyelectrolyte (PE) surface. However, the use of 5×Denhardt's and DNA solutions in wash buffers and in the extension mixture had almost no effect on the background in the acceptor 2 channel. The background on a novel surface was similar to the background on a regular (PE) surface in the acceptor 2 channel.

In the real time sequencing experiments, when extension was followed under a microscope, the acceptor 1 background was still higher than on PE-surface, when an additional step of washing was introduced. The biotinylated duplex was bound to a streptavidin surface using a standard Visigen protocol followed by an additional wash with 5×Denhardt's solution and 200 μg/mL of tRNA in 1×KB. Denhardt's solution (5× final concentration) and tRNA (200 μg/ml) was added into the sequencing mixture.

Because a functional group of a silane does not participate in a chemical reaction and just makes the surface either more hydrophilic or hydrophobic depending on its nature, other silanes such as cyano-silane modified glass and mercapto-silane modified glass were investigated. Streptavidin adsorbs to both surfaces, although at different pH (pH 4.5 works the best for mercapto-silane, pH 7.0 works best for cyano-silane). The real time extension experiments gave similar background intensity around 2750-2800, compared to the epoxy-silane modified glass.

The effect of moving a sequencing reaction away from the surface on background was also studied. The sandwiched streptavidin double layer (2 molecules of streptavidin are held together by bis-biotin) directly adsorbed to the glass was used and the results were compared with those achieved on the streptavidin mono-layer adsorbed to the glass. The results were similar. For both mono-streptavidin layers and the sandwiched streptavidin double layers, the background was again about 2750-2800.

Background Reduction Agents

The inventors have found that generally, to reduce background of a substrate, especially treated substrates, the treatments need to block hydrophobic binding sites on the surface (including streptavidin treated surfaces) or need to interfere with nucleotide, polymerase or duplex binding to the hydrophobic sites on the surfaces. The inventors have found that non-ionic detergents such as Triton X-100, Tween 20, etc. act of reduce background fluorescence. These detergents have a polyethylene glycol (hydrophilic) part that orients toward the aqueous part of the solution and a hydrophobic part that actually sticks to or orients toward a hydrophobic surface or a hydrophobic structure or region of a molecule, molecular complex or molecular assembly. Surprisingly, washing the treated surface with glycerol and adding glycerol into the sequencing mixture gave the highest background reduction. The inventors believe that glycerol is a more effective background reducing agent than the detergents because glycerol is a smaller molecule having only 3 hydroxyl groups and 3 carbon atoms. While not meaning to be bound by any theory, the inventors believe that glycerol has a superior match of properties for interacting with a streptavidin surface and thereby blocking the hydrophobic part of the streptavidin surface. The inventors believe that the critical properties of a background reducing agent are hydrophobicity, the nature, properties and characteristics of its hydrophobic portion relative to the hydrophilic portion, and the match between its hydrophobicity of the background reducing agent and the hydrophobicity of the surface. Thus, glycerol appears to have characteristics that are well suited for reducing background of streptavidin surfaces.

Suitable background reducing agents include, without limitation, any molecule having hydrophilic and hydrophobic portions and either convert surface hydrophobic sites into hydrophilic sites through association with the surface hydrophobic sites or block assess to the surface hydrophobic sites by competitive binding to the surface hydrophobic sites and hydrophobic sites on the components in the solution to which the surfaces are being exposed. Exemplary examples of such agents include, without limitation, small molecules having a hydrophobic portion and a hydrophilic portion, glymes, anionic surfactants, cationic surfactants, non-ionic surfactants and any other molecule having a hydrophobic and hydrophilic portion sufficient to reduce reagents binding to the hydrophobic portions of a surface exposed to a solution including the reagents and mixtures or combinations thereof. The reagents can be any set of reagents used in an single molecule reaction such as single molecule nucleic acid sequencing, single molecule amino acid sequencing, single molecule polysaccharide sequencing, or any other reaction being followed at the single molecular level where one or more reagents are attached to a surface. Exemplary small molecules include, without limitation, ethylene glycol, propylene glycol, glycerol, polymethyleneoxides, polyethylene oxides, polypropylene oxides, glymes, C₃-C₆-hydroxy carboxylic acids (where the molecule can have one hydroxy group per carbon atom not bearing the carboxy moiety), C₄-C₈-dicarboxylic acids, hydroxy-C₄-C₈-dicarboxylic acids (where the molecule can have one hydroxy group per carbon atom not bearing the carboxy moiety), C₂-C₆-polyamines (where the molecule can have one hydroxy group per carbon atom not bearing the carboxy moiety), or the like, or mixture or combinations thereof.

Glycerol

Addition of 10% glycerol reduces the background significantly as shown in the Table and was achieved using the following protocol:

Slides were cleaned by argon plasma (30 min at the medium power) followed by epoxy-silanization (30 min, vapor in argon flow) as described above. Streptavidin was adsorbed (1 mg/mL, 15 h in 10 mM Tris buffer, pH 8.0) to the slides that were kept at +4° C. The A1488-biotin-duplex (10 pM) was attached to the streptavidin surface in 1×KB (10 min, RT) followed by washing first in Tris buffer (5 min, RT) and then in 1×KB phosphate buffer containing 10% of glycerol (5 min, RT). Then a standard sequencing mixture containing also 10% of glycerol was added followed by data collection. The resulting data is shown in Table V.

TABLE V
Effects of Glycerol on Fluorescent Background Intensity

| | Background Intensity, | Background Intensity, |
|---|---|---|
| % Glycerol | Acceptor 1 | Acceptor 2 |
| 0 | 2845 | 2556 |
| 10 | 2600 | 2500 |

DNA Binding to Glass-Streptavidin Surface

DNA binding to the plasma cleaned glass was specific. When streptavidin was adsorbed biotinylated duplex binds much better than in the absence of the streptavidin layer, as shown in Table VI.

TABLE VI
Biotinylated-Duplex Binding to Glass/Strep and Glass Surfaces

| | | Number of Spots |
|---|---|---|
| Surface | DNA | (average) |
| Glass/Strep | Biotin-Duplex | 300 |
| Glass | Biotin-Duplex | 20 |

Polymerase Binding to Glass-Streptavidin Surface

Binding of biotinylated and non-biotinylated polymerase to glass with the adsorbed streptavidin layer gave a ratio of specific to non-specific binding about 1:1, as estimated from the data shown in Table VII.

TABLE VII
Polymerase Binding to Glass/Strep Surfaces

| | | Number of Spots |
|---|---|---|
| Surface | Polymerase @ 12 pM | (average) |
| Glass/Strep | Biotin-KlExo-Alexa488 | 561 |
| Glass/Strep | KlExo-Alexa488 | 204 |

To increase the specificity of the binding of biotinylated polymerase to the streptavidin coated surface, 2.5% glycerol and 1% triton 100 were used in the pre-wash step as well as in the binding buffer. Binding in the presence of streptavidin or DOA was also accomplished. However, non-specific binding was not reduced significantly. When we added polymerases at 1 pM for 30 min., non-specific binding was increased. When we added polymerases at 9 pM for 15 seconds, specificity of the binding was increased, as shown in Table VIII.

TABLE VIII
Short-time Polymerase Binding to Glass/Strep Surfaces

| | | Number of Spots |
|---|---|---|
| Surface | Polymerase @ 9 pM | (average) |
| Glass/Strep | Biotin-KlExo-Alexa488 | 300 |
| Glass/Strep | KlExo-Alexa488 | 50 |

Polymerase extension reaction with a polymerase immobilized on the surface. Polymerase immobilization was carried out as follows: Glass cover slips were plasma cleaned 30 min at the medium power in argon plasma at 500 mtorr pressure. Streptavidin was adsorbed overnight at 4° C. at 1 mg/ml in Tris buffer. The Streptavidin treated cover slips were then washed with Tris (30 min., RT), washed with 1×KB (5 min., RT). After washing, K1Exo-Alexa488 polymerase was immobilized at 6 pM in 1×KB (10 min, RT), followed by washing with 1×KB (5 min, RT). Extension reactions were carried out as follows: After polymerase binding and washing, an extension mixture including γ-labeled-G2-Oy650+γ-labeled-A2-A1610 (0.5 uM+BotIV Duplex @ 10 nM in 1×KB containing 2.5 mM nCl₂ and 10% glycerol just before data collection. γ-labeled-G2-Oy650 and γ-labeled-A2-A1610 were SAP treated prior to and during use. SAP selectively destroys any unlabeled nucleotide contaminants.

Extension with Polymerase Adsorbed to Silanized Glass Surface

In all enzyme immobilized experiments, a standard protocol was used as follows: a polymerase enzyme was immobilized at 10 pM in 1×KB (10 min, RT), followed by washing with 1×KB+phosphate (5 min, RT), and an extension mixture including γ-labeled-G2-Oy650+γ-labeled-A2-A1610 @ 0.5 uM+BotIV Duplex @ 10 nM in 1×KB containing 2.5 mM MnCl₂ and 10% glycerol was added just before data collection. γ-Labeled-G2-Oy650 and γ-labeled-A2-A1610 were SAP treated and no heat was used, which kept the SAP active during the extension reactions. Polymerase enzyme adsorption gave reproducibly 300-350 spots. The donor lifetime was similar for both immobilized labeled polymerase and labeled duplex.

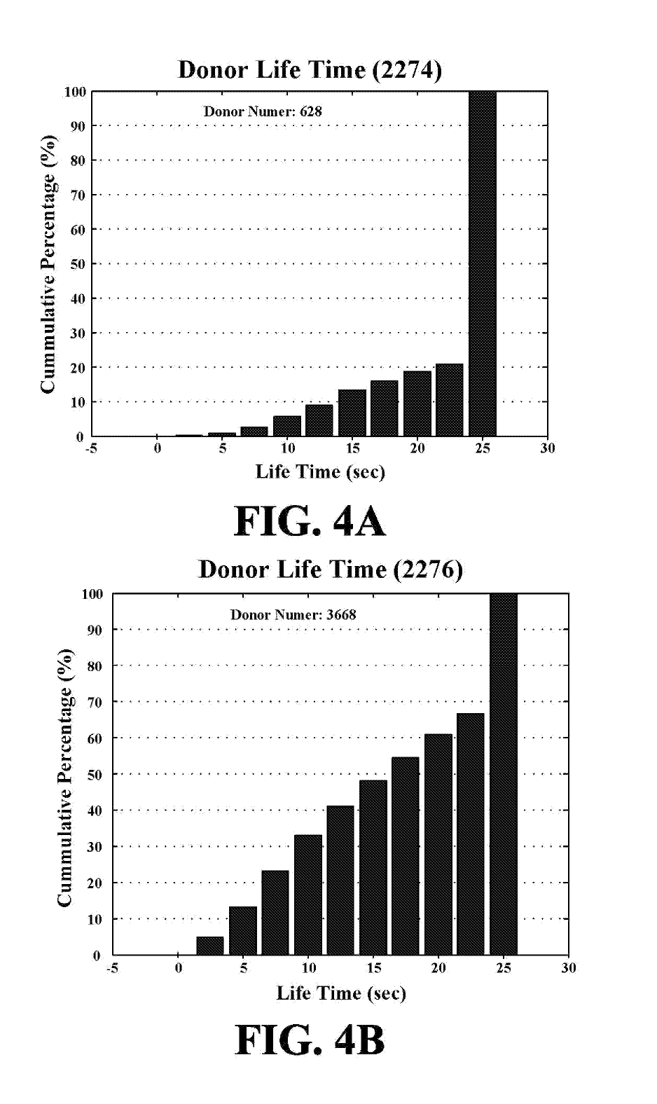

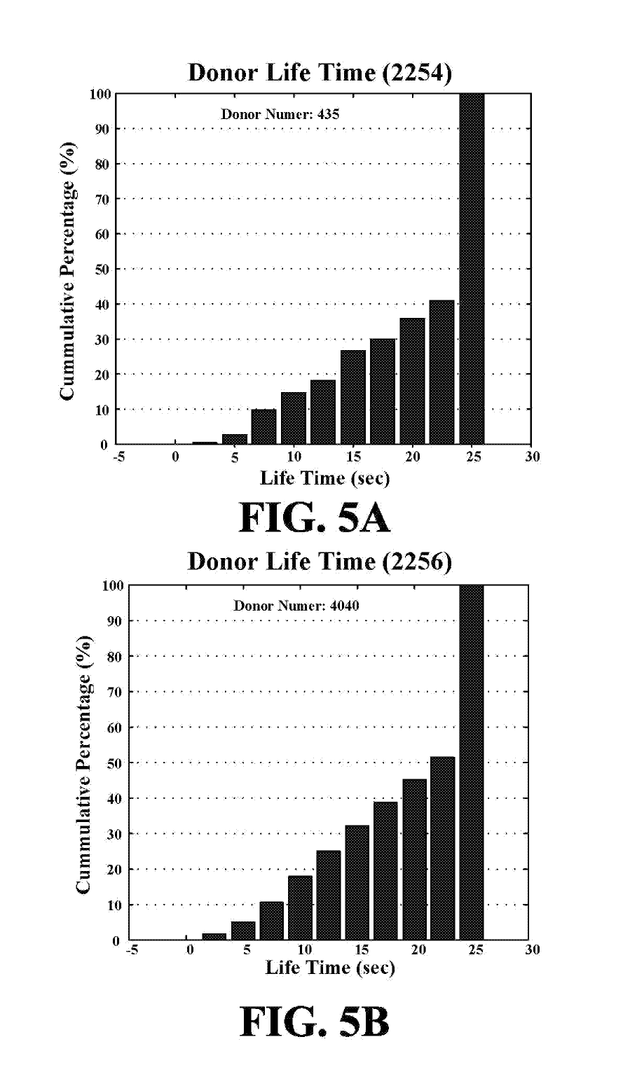

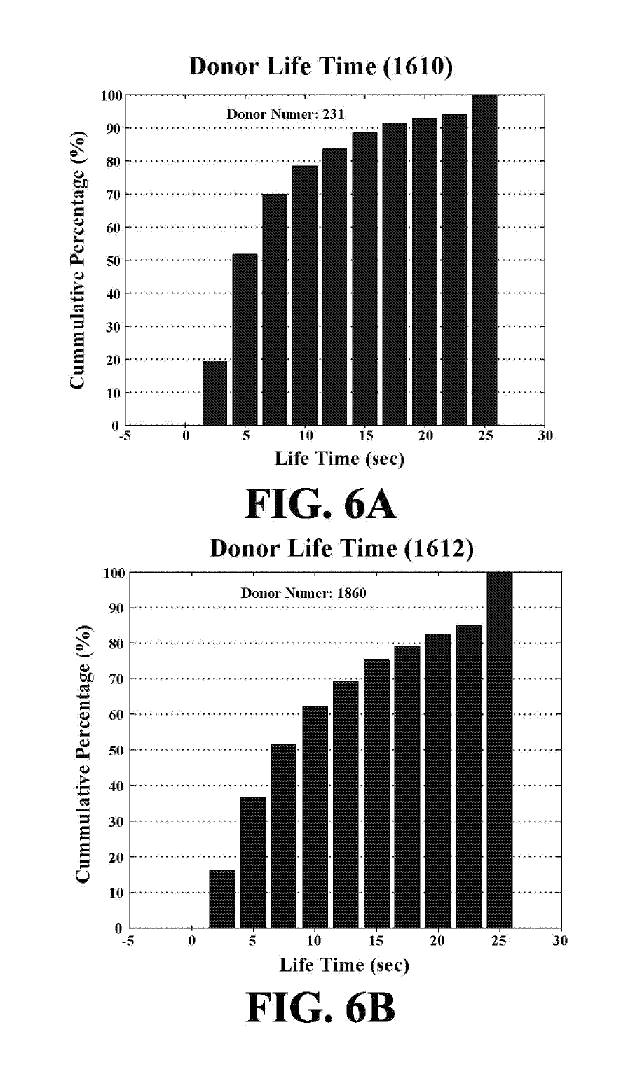

Referring now to FIGS. 4A&B, life times of A1488 are shown for Streptavidin treated, Si-epoxy functionalized glass during the extension reaction and after the extension reaction. Referring now to FIGS. 5A&B, life times of A1488 are shown for Streptavidin treated glass during the extension reaction and after the extension reaction. Referring now to FIGS. 6A&B, life times of A1488 are shown for Streptavidin treated PES (polyelectrolyte surface) as a control.

A cumulative donor fluorescent life time is calculated for all the donors in a given experiment based on the donor life time computed for each donor. This cumulative donor life time allows for estimating the percent donors with a particular life time.

The bars show the percent of donors that have entered a dark state (i.e., photobleached) by the indicated times. The experimental details for biotin duplex binding studies are described above under the heading “On Surface Post Extension Detection Experimental Protocol”, but using only steps 14, 10, and 11. The experimental details for the biotin duplex post extension studies are also described under the heading “On Surface Post Extension Detection Experimental Protocol”, using all of the steps.

Looking at the results shown in FIG. 4A for Biotin Duplex Binding on Streptavidin treated, Si-epoxy functionalized glass, 20% of molecules had life time less than or equal to 22.5 seconds, while 80% of molecules had life time greater than 22.5 seconds. Looking at the results shown in FIG. 4B for Biotin Duplex Post Extension on Streptavidin treated, Si-epoxy functionalized glass, 66% of molecules have life time less than or equal to 22.5 seconds, while 34% of molecules have life time greater than to 22.5 seconds.

Looking at the results shown in FIG. 5A for Biotin Duplex Binding on Streptavidin treated glass, 40% of molecules had life time less than or equal to 22.5 seconds, while 60% of molecules had life time greater than 22.5 seconds. Looking at the results shown in FIG. 5B for Biotin Duplex Post Extension on Streptavidin treated glass, 50% of molecules have life time less than or equal to seconds, while 50% of molecules have life time greater than to 22.5 seconds.

Looking at the results shown in FIG. 6A for Biotin Duplex Binding on Streptavidin treated, Polyelectrolyte functionalized glass, 92% of molecules had life time less than or equal to 22.5 seconds, while 8% of molecules had life time greater than 22.5 seconds. Looking at the results shown in FIG. 6B for Biotin Duplex Post Extension on Streptavidin treated, Polyelectrolyte functionalized glass, 85% of molecules have life time less than or equal to seconds, while 15% of molecules have life time greater than to 22.5 seconds.

From the graphs of FIGS. 4A-6B, it is clear that the surfaces of this invention evidence a significant increase cumulative fluorophore lifetimes compared to the polyelectrolyte control surface.

### CONCLUSIONS

Silanized glass surfaces can be used for protein adsorption. Epoxy-silane, cyano-silane and mercapto-silane modified glass cover slips were used for the adsorption of streptavidin. An adsorbed streptavidin layer is stable to multiple washes with different buffers and can be used for surface-supported sequencing. When biotinylated duplexes labeled with a donor-dye were bound to or absorbed onto the streptavidin layer, the average donor persistence increased up to 2.5 times that of a control polyelectrolyte surface. Similarly, in sequencing reaction performed on the surfaces of this invention, significant donor lifetimes increases were observed relative to a polyelectrolyte control surface.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A surface composition comprising:
a substrate and
a functionalized layer disposed on a surface thereof, an absorption layer disposed on a surface thereof, or an absorption layer disposed on a functionalized layer disposed on a surface thereof,
where the functionalized layer includes sites capable of the absorption layer or capable of absorbing or binding a first molecule, molecular complex, or molecular assembly or a plurality of first molecules, complexes, assemblies or mixtures or combinations thereof
where the absorption layer include sites capable of absorbing or binding the first molecule, molecular complex, or molecular assembly or the plurality of first molecules, complexes, assemblies or mixtures or combinations thereof,
where each first molecule, complex and assembly includes a first fluorescent dye or fluorophore, and
where the composition increases fluorescent dye or fluorophore lifetime relative to a polyelectrolyte surface.

2. The composition of claim 1, wherein the substrate is transparent to a desired range of frequencies of electromagnetic radiation.

3. The composition of claim 1, wherein the substrate comprises an inorganic oxides a metal, a plastic or polymer, a composite of any of the afore mentioned materials, or mixtures or combinations thereof.

4. The composition of claim 1, wherein the substrate is a plasma cleaned substrate.

5. The composition of claim 1, wherein the absorption layer comprises a polymer, a proteins, other bio-molecules capable of absorbing or binding the molecules, complexes or molecular assemblies or mixtures or combinations thereof.

6. The composition of claim 1, wherein the polymer is selected from the group consisting of polyamides, polyimides, polyesters, polyalkyleneoxides, polyvinlychlorides, ionomers, hydrogels, or mixture or combinations thereof, and the protein is selected from the group consisting of streptavidin, neutravidin, avidin, staphylococcal Proteins A and G, or mixture or combinations thereof.

7. The composition of claim 1, wherein the functionalized layer comprises a silanization layer.

8. The composition of claim 7, wherein the silanization layer comprises a silanizing agent of the general formula Z-R-SiA¹A²A³, where Z is a head group, R is a linking group, and A¹, A² and A³ at least one of these group being hydrolysable or displaceable

9. The composition of claim 7, wherein the silanization layer comprises an epoxy silanization layer.

10. The composition of claim 1, further comprising:
a plurality of molecules, molecular complexes, molecular assemblies or mixtures or combinations thereof immobilized on the absorption layer, some or all of the molecules, complexes, or assemblies including a fluorescent dye or fluorophore capable of being detected by a detection system.

11. The composition of claim 10, further comprising:
a solution including second molecules, molecular complexes, molecular assemblies, or mixtures or combinations thereof,
where some or all of the second molecules, complexes or assemblies include a second fluorescent dye or fluorophore, and
where the dyes and fluorophores and interactions between the first dye or fluorophore and second dye or fluorophore are capable of being detected by the detection system.

12. A surface composition comprising:
a substrate,
a functionalized layer disposed on a surface thereof, and
an absorption layer disposed on the functionalized layer,
where the functionalized layer is adapted to bond or absorb the absorption layer,
where the absorption layer include sites capable of absorbing or binding a first molecule, molecular complex, or molecular assembly or a plurality of first molecules, complexes, assemblies or mixtures or combinations thereof,
where each first molecule, complex and assembly includes a first fluorescent dye or fluorophore, and
where the composition increases fluorescent dye or fluorophore lifetime relative to a polyelectrolyte surface.

13. The composition of claim 12, wherein the substrate is transparent to a desired range of frequencies of electromagnetic radiation.

14. The composition of claim 12, wherein the substrate comprises an inorganic oxides a metal, a plastic or polymer, a composite of any of the afore mentioned materials, or mixtures or combinations thereof.

15. The composition of claim 12, wherein the substrate is a plasma cleaned substrate.

16. The composition of claim 12, wherein the absorption layer comprises a polymer, a proteins, other bio-molecules capable of absorbing or binding the molecules, complexes or molecular assemblies or mixtures or combinations thereof.

17. The composition of claim 12, wherein the polymer is selected from the group consisting of polyamides, polyimides, polyesters, polyalkyleneoxides, polyvinlychlorides, ionomers, hydrogels, or mixture or combinations thereof, and the protein is selected from the group consisting of streptavidin, neutravidin, avidin, staphylococcal Proteins A and G, or mixture or combinations thereof.

18. The composition of claim 12, wherein the functionalized layer comprises a silanization layer.

19. The composition of claim 18, wherein the silanization layer comprises a silanizing agent of the general formula Z-R-SiA¹A²A³, where Z is a head group, R is a linking group, and A¹, A² and A³ at least one of these group being hydrolysable or displaceable

20. The composition of claim 18, wherein the silanization layer comprises an epoxy silanization layer.

21. The composition of claim 12, further comprising:
a plurality of molecules, molecular complexes, molecular assemblies or mixtures or combinations thereof immobilized on the absorption layer, some or all of the molecules, complexes, or assemblies including a fluorescent dye or fluorophore capable of being detected by a detection system.

22. The composition of claim 21, further comprising:
a solution including second molecules, molecular complexes, molecular assemblies, or mixtures or combinations thereof,
where some or all of the second molecules, complexes or assemblies include a second fluorescent dye or fluorophore, and
where the dyes and fluorophores and an interaction between the first dye or fluorophore and second dye or fluorophore are capable of being detected by the detection system.

23. A method for preparing surface compositions comprising the steps of:
cleaning a substrate to reduce or eliminate fluorophores from surfaces of the substrate or from the substrate itself, and
contacting the substrate with an absorbent under conditions to form an absorption layer on a surface of the substrate,
where the absorption layer include sites capable of absorbing or binding a first species selected from the group consisting of a molecule, molecular complex, or molecular assembly or a plurality of first species selected from the group consisting of molecules, complexes, assemblies or mixtures or combinations thereof,
where each first species includes a first fluorescent dye or fluorophore, and
where the substrate increases fluorescent dye or fluorophore lifetime relative to a polyelectrolyte surface.

24. The method of claim 23, further comprising the steps of:
prior to the contacting step, placing the cleaned substrate on a support rack in a bottle including a cap having an aperture and a bottom having a plurality of aperture,
placing a tube within the bottle containing a functionalizing agent,
capping the bottle,
inserting a pipette through the cap aperture into the tube above or below a surface of the functionalizing agent,
connecting the pipette to a source of an inert gas,
supplying a flow of inert gas to the bottle via the pipette at a rate sufficient to evaporate or entrain the functionalizing agent in the inert gas flow and sufficient for a pressure in the bottle to be maintained at a desired pressure below the rupture pressure of the bottle, and
continuing the flow for a time sufficient to achieve a desired degree of substrate functionalization to form a substrate having a functionalized layer formed one or all surfaces of the substrate, and
where, in the contacting step, the substrate comprises a functionalized substrate,
where the functionalized layer is adapted to bond, absorb or support the absorption layer,
where the absorption layer include sites capable of absorbing or binding a first species selected from the group consisting of a molecule, molecular complex, or molecular assembly or a plurality of first species selected from the group consisting of molecules, complexes, assemblies or mixtures or combinations thereof,
where each first species includes a first fluorescent dye or fluorophore, and
where the composition increases fluorescent dye or fluorophore lifetime relative to a polyelectrolyte surface.

25. A method for preparing surface compositions comprising the steps of:
2 cleaning a substrate to reduce or eliminate fluorophores from surfaces of the substrate or from the substrate itself,
placing the cleaned substrate on a support rack in a bottle including a cap having an aperture and a bottom having a plurality of aperture,
placing a tube within the bottle containing a functionalizing agent,
capping the bottle,
inserting a pipette through the cap aperture into the tube above or below a surface of the functionalizing agent,
connecting the pipette to a source of an inert gas,
supplying a flow of the inert gas to the bottle via the pipette at a rate sufficient to evaporate or entrain the functionalizing agent in the inert gas flow and sufficient for a pressure in the bottle to be maintained at a desired pressure below the rupture pressure of the bottle, and
continuing the flow for a time sufficient to achieve a desired degree of substrate functionalization to form a substrate having a functionalized layer formed one or all surfaces of the substrate,
where the functionalized layer is adapted to bond, absorb or support the absorption layer, or to absorb or bond a first species selected from the group consisting of a molecule, molecular complex, or molecular assembly or a plurality of first species selected from the group consisting of molecules, complexes, assemblies or mixtures or combinations thereof,
where each first species includes a first fluorescent dye or fluorophore, and
where the composition increases fluorescent dye or fluorophore lifetime relative to a polyelectrolyte surface.

26. A method for immobilizing molecules, molecular complexes or molecular assemblies comprising the steps of:
providing a substrate comprising an absorption layer disposed on a surface thereof, an absorption layer disposed on a functionalized layer disposed on a surface thereof, or a functionalized layer disposed on a surface thereof,
contacting the surface with a solution comprising a plurality of species selected from the group consisting of molecules, molecular complexes, molecular assemblies or mixtures or combinations thereof, where some or all of the species include a first detectable label, where the contacting is under conditions sufficient to immobilize the species on the functionalized layer or the absorption layer so that a majority of the immobilized species are separately or individually detectable,
placing the resulting composition in a detection system, and
detecting the labels.

27. The method of claim 26, further comprising the steps of:
prior to the placing step, contacting the resulting composition with a solution comprising a plurality of second species selected from the group consisting of molecules, molecular complexes, molecular assemblies or mixtures or combinations thereof, where some or all of the second species include a second detectable label, where the two labels are designed to interact and where at least one of the labels is directly detectable, and
detecting the at least one of the two labels directly and their interactions.

28. The method of claim 27, wherein the labels are fluorescent labels and further comprising the steps of:
after the placing step, irradiating the resulting composition with light of a given frequency sufficient to excite the first label, and
detecting fluorescent light emitted by the two labels, where the fluorescent light emitted by the second label results from fluorescence resonance energy transfer from an excited first label proximate the second label.

29. The method of claim 28, wherein the first species comprises molecular complex including a primer, a template, and a polymerizing agent, where the first label is a donor dye or fluorophore, and wherein the second species comprises nucleotide or dNTP types for the polymerizing agent, where one, two, three or four of the nucleotide or dNTP types include a first, second, third or fourth acceptor dye or fluorophore, the acceptors are the same or different and are capable of undergoing fluorescent resonance energy transfer with an excited donor dye or fluorophore, and wherein the detecting detects donor fluorescence and acceptor fluorescence resulting from fluorescence resonance energy transfer from an excited donor proximate the acceptor.

30. The method of claim 29, further comprising the step of:
relating the fluorescence resonance energy transfer events to a sequence of nucleotide or dNTP incorporations onto the primer complementary of a base sequence of the template.
